(19) United States
(12) Patent Application Publication
(10) Pub. No.: US 2005/0173327 A1
(43) Pub. Date: Aug. 11, 2005

(54) Side seal of a pressure filter

(75) Inventors: Mark Schroder, Louisville, KY (US); Steve Haub, Louisville, KY (US)

Correspondence Address: CROWELL & MORING LLP;INTELLECTUAL PROPERTY GROUP, P.O. BOX 14300, WASHINGTON, DC, 20044-4300, US

(73) Assignee: MANN & HUMMEL GMBH, Ludwigsburg (DE)

(21) Appl. No.: 11/033,264

(22) Filed: Jan. 12, 2005

Related U.S. Application Data
(60) Provisional application No. 60/535,809, filed on Jan. 13, 2004.

(51) Int. Cl. B01D 25/172

(52) U.S. Cl. 210/224; 210/450; 210/231; 100/104

(57) ABSTRACT

A side seal of a pressure filter includes first and second sealing members, a mechanical mechanism, and an actuator. The first sealing member is moveable relative to the second sealing member. The mechanical mechanism moves the fist sealing member to engage or disengage with the second sealing member. The actuator uses the mechanical mechanism to move the first sealing member to engage or disengage with the second sealing member.

This application claims the benefit of U.S. Provisional Application No. 60/535,809, filed Jan. 13, 2004, the entire disclosure of which is incorporated herein by reference.

### FIELD OF THE INVENTION

The present invention relates to a side seal of a pressure filter.

### THE BACKGROUND OF THE INVENTION

FIG. 1 is a cross sectional view of a conventional side seal 1 of a pressure filter. The conventional side seal 1 includes first and second elongated sealing members 2, 3, each of which has a sealing surface. The cross sectional view of FIG. 1 is perpendicular to the longitudinal direction of the sealing members 2, 3.

In the illustrated conventional side seal 1, the second sealing member 3 is stationary relative to the pressure filter, while the first sealing member 2 is moveable relative to the second sealing member 3 to engage or disengage the sealing members 2, 3. When the sealing members 2, 3 are engaged with each other, the sealing surfaces of the sealing members 2, 3 are pressed against each other to seal the gap 4 between the sealing members 2, 3, preventing fluid flow though the gap 4. When the sealing members 2, 3 are disengaged with each other, the sealing surfaces of the sealing members 2, 3 are not in contact, opening up the gap 4 for fluid flow.

The conventional side seal 1 may also have a guide member 5 that is stationary relative to the pressure filter. The guide member 5 is used to direct the movement of the first sealing member 2 to ensure that the sealing surfaces are in proper contact when the sealing members 2, 3 are engaged.

The movement of the first sealing member 2 is accomplished using an inflatable air hose 6. The inflatable hose 6 is placed between the first sealing member 2 and the guide member 5, and extends in the longitudinal direction of the sealing members 2, 3. Generally, the guide member 5 is at least as long as the inflatable hose 6 to support the inflatable hose 6.

To move the first sealing member 2 towards the second sealing member 3, air is pumped into the hose 6 via a tube to inflate the hose 6. As the hose 6 inflates, it pushes the first sealing member 2 towards the second sealing member 3. When the sealing members 2, 3 are engaged, the hose 6 remains inflated and presses the first sealing member 2 against the second sealing member 3 to ensure a proper seal.

The conventional side seal 1 may also include a spring 7 that biases the first sealing member 2 in a direction away from the second sealing member 3. In other words, the spring force pushes the first sealing member 2 in a direction away from the second sealing member 3. When the air in the hose 6 is released to deflate the hose 6, the spring 7 pushes the first sealing member 2 away from the second sealing member 3 to open up the gap 4 between the sealing members 2, 3 and to flatten the hose 6.

The use of an inflatable hose to position the first sealing member has certain advantages. For example, the pressure applied by the hose against the first sealing member is substantially uniform longitudinally along the first sealing member, thus ensuring the sealing pressure between the first and second sealing members is substantially uniform longitudinally. The reasons why the sealing pressure is uniformly distributed are (1) that the hose can extend along the entire length of the first sealing member and apply pressure along the entire length of the first sealing member and (2) that the pressure apply by the hose is substantially uniform along the length of hose because the air pressure inside the hose in uniform.

Applicants have discovered that the inflatable hose also has drawbacks in certain applications. For example, when the pressure filter is used to filter a hot fluid, such as hot oil, the hose becomes brittle over a period of time. Especially when it is used in hot oil applications, the hose tends to grow in length, and the hose clamps at the ends of the hose tend to turn in the ends of the hose, preventing the first sealing member from returning fully to the disengage position.

Because of the perceived advantages of the inflatable hose, efforts to overcome the above-noted drawbacks of the inflatable hose have focused on improving the hose material's ability to withstand hot fluid, especially hot oil. For example, Applicants have tested several hose materials, such as nitrile, buna, carboxylated nitrile, Viton™ and Teflon™. However, none of the tested materials provide sufficient durability (i.e., more than 3 to 4 years).

### SUMMARY OF THE INVENTION

Having failed to find a hose material that has the required durability, the inventors started to think out of the box and invented several side seals that do not use an inflatable hose. Instead, the side seals use mechanical mechanisms to engage and disengage the sealing members. The mechanical mechanisms can withstand hot fluid, especial hot oil, for an extended period of time. To the inventors' surprise and contrary to the common believes in the art, the side seals of the present invention function satisfactorily even though the mechanical mechanisms do not applied a uniform pressure longitudinally along the sealing member. An additional advantage of the side seal of the present invention is that it uses less air to move the sealing member.

In accordance with one aspect of the invention, a side seal of a pressure filter includes first and second sealing members, a pivotable arm, and an actuator. The first sealing member is moveable relative to the second sealing member. The pivotable arm is pivotable relative to the frame of the pressure filter and is engageable with the first sealing member. The pivoting movement of the pivotable arm moves the first sealing member to engage or disengage with the second sealing member. The actuator is engageable with the pivotable arm and is adapted to move pivotably the pivotable arm and in turn the first sealing member to engage or disengage with the second sealing member.

In accordance with another aspect of the invention, a side seal of a pressure filter includes first and second sealing members, a cam, and an actuator. The first sealing member is moveable relative to the second sealing member. The cam is rotatable relative to the frame of the pressure filter. The rotation of the cam moves the first sealing member to engage or disengage with the second sealing member. The actuator is engageable with the cam and is adapted to rotate the cam and in turn move the first sealing member to engage or disengage with the second sealing member.

In accordance with a further aspect of the invention, a side seal of a pressure filter includes first and second sealing members, a wedge mechanism, and an actuator. The first sealing member is moveable relative to the second sealing member. The wedge mechanism includes first and second wedge members, with each wedge member having a wedge surface. The wedge surfaces of the wedge members are slidably engaged with each other. The first wedge member is connected to the first sealing member. The actuator is connected to the second wedge member of the wedge mechanism and is adapted to move the second wedge member so that the wedge surface of the second wedge member slides relative to the wedge surface of the first wedge member to move the first sealing member to engage or disengage with the second sealing member.

### BRIEF DESCRIPTION OF THE DRAWINGS

FIG. 1 is a cross sectional view of a conventional side seal of a pressure filter.

FIG. 2a is a cross sectional view of a side seal of a pressure filter according to the present invention, wherein a pivotable arm is used to engage or disengage the sealing members of the side seal, and wherein the sealing members of the side seal are disengaged.

FIG. 2b is the same view of FIG. 2a, except that the sealing members are engaged.

FIG. 3a is a cross sectional view of another side seal of a pressure filter according to the present invention, wherein a cam is used to engage or disengage the sealing members of the side seal, and wherein the sealing members of the side seal are disengaged.

FIG. 3b is the same view of FIG. 3a, except that the sealing members are engaged.

FIG. 4a is a cross sectional view of a further side seal of a pressure filter according to the present invention, wherein a wedge mechanism is used to engage or disengage the sealing members of the side seal, and wherein the sealing members of the side seal are disengaged.

FIG. 4b is the same view of FIG. 4a, except that the sealing members are engaged.

FIG. 4c is a side view of the wedge mechanism of the side seal of FIG. 4a.

FIG. 4d is a top view of the wedge mechanism of the side seal of FIG. 4a.

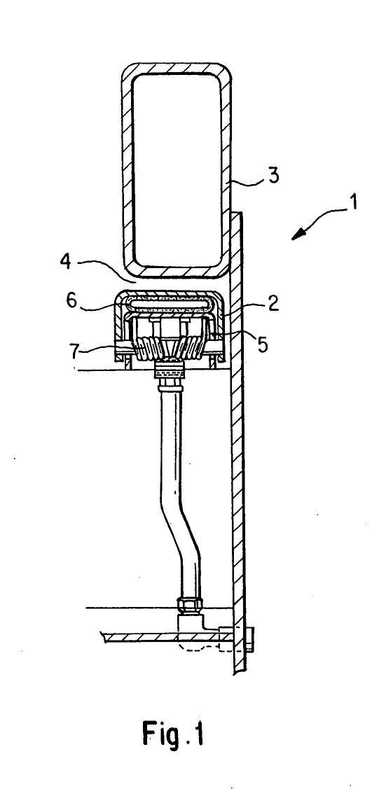

### DETAILED DESCRIPTION OF PREFERRED EMBODIMENTS

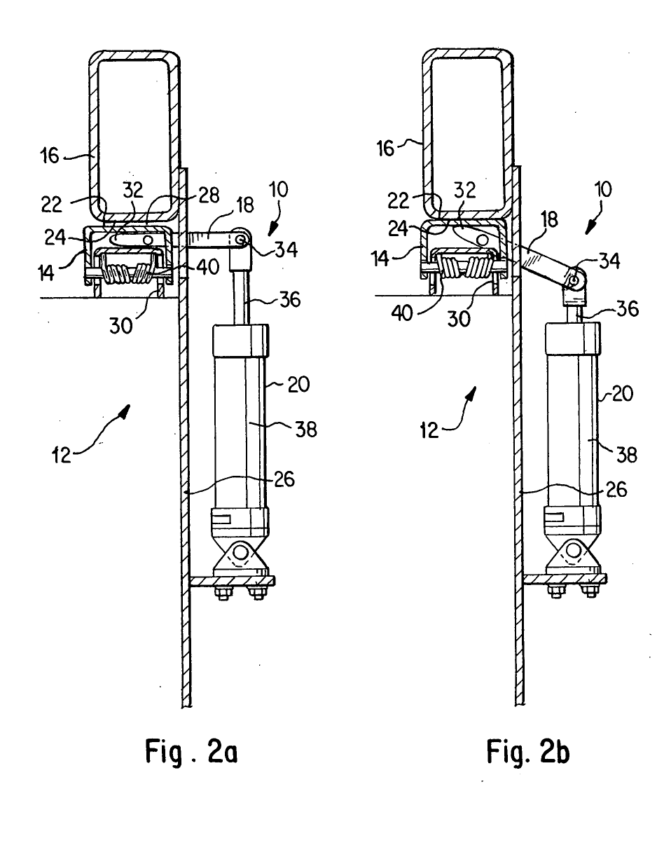

FIGS. 2a and 2b illustrate a preferred embodiment of the present invention. In this preferred embodiment, the side seal 10 of a pressure filter 12 includes first and second sealing members 14, 16, a pivotable arm 18, and an actuator 20.

The first sealing member 14 preferably can move towards or away from the second sealing member 16, while the second sealing member 16 preferably is attached to the frame 26 of the pressure filter 12 and therefore is stationary. Alternatively, both sealing members may be moveable.

Each of the first and second sealing members 14, 16 may include a sealing surface 22, 24. As shown in FIG. 2b, when the sealing members 14, 16 are engaged with each other, the sealing surfaces 22, 24 of the sealing members 14, 16 preferably are pressed against each other to seal the gap 28 between the sealing members 14, 16 to prevent fluid flow though the gap 28. When the sealing members 14, 16 are disengaged with each other, as shown in FIG. 2a, the sealing surfaces 22, 24 of the sealing members 14, 16 preferably are not in contact with each other, opening up the gap 28 for fluid flow.

The side seal 10 may also have a guide member 30 that may be attached to the frame 26 of the pressure filter 12 and therefore may be stationary relative to the pressure filter 12. The guide member 30 preferably is used to guide the movement of the first sealing member 14 to ensure that the sealing surfaces 22, 24 are in proper contact when the sealing members 14, 16 are engaged.

The pivotable arm 18 preferably is pivotably connected to the guide member 30, although the pivotable arm can be pivotably connected to any stationary object, including the frame of the pressure filter. In the illustrated embodiment, the first end 32 of the pivotable arm 18 is used to push the first sealing member 14 towards the second sealing member 16. The second end 34 of the pivotable arm 18 is pivotably connected to the actuator 20, allowing the actuator 20 to pivotably move the pivotable arm 18.

The actuator may be of any suitable type that can be used to move the pivotable arm 18, such as a pneumatic, hydraulic or electric actuator of the rotary or linear type. In the illustrated embodiment, the actuator is a pneumatic piston/cylinder arrangement 20. The piston 36 of the piston/cylinder arrangement 20 is connected to the pivotable arm 18, while the cylinder 38 is connected to the frame 26 of the pressure filter 12.

The side seal 10 may also include a spring 40 that biases the first sealing member 14 in a direction away from the second sealing member 16. In other words, the spring force pushes the first sealing member 14 in a direction away from the second sealing member 16.

In operation, from the position shown in FIG. 2a, compressed air is admitted to the piston rod side of the cylinder 38, pulling the piston 36 into the cylinder 38. This action causes the piston 36 to turn the pivotable arm 18 in the clock-wise direction. As a result, the first end 32 of the pivotable arm 18 pushes the first sealing member 14 towards the second sealing member 16 against the spring force until the sealing surfaces 22, 24 of the sealing members 14, 16 come into contact to form a seal (FIG. 2b). The compressed air in the cylinder 38 ensures that the sealing surfaces 22, 24 are always in proper contact to form a secure seal. To disengage the sealing members 14, 16, the air in the cylinder 38 is released, and the spring force pushes the first sealing member 14 away from the second sealing member 16 to open up the gap between the sealing members 14, 16 and to pull the piston 36 out of the cylinder 38.

Alternatively, a double acting piston/cylinder arrangement may be used as the actuator. The double acting piston/cylinder arrangement can be used to both engage and disengage the sealing members 14, 16, and the spring 40 can be eliminated.

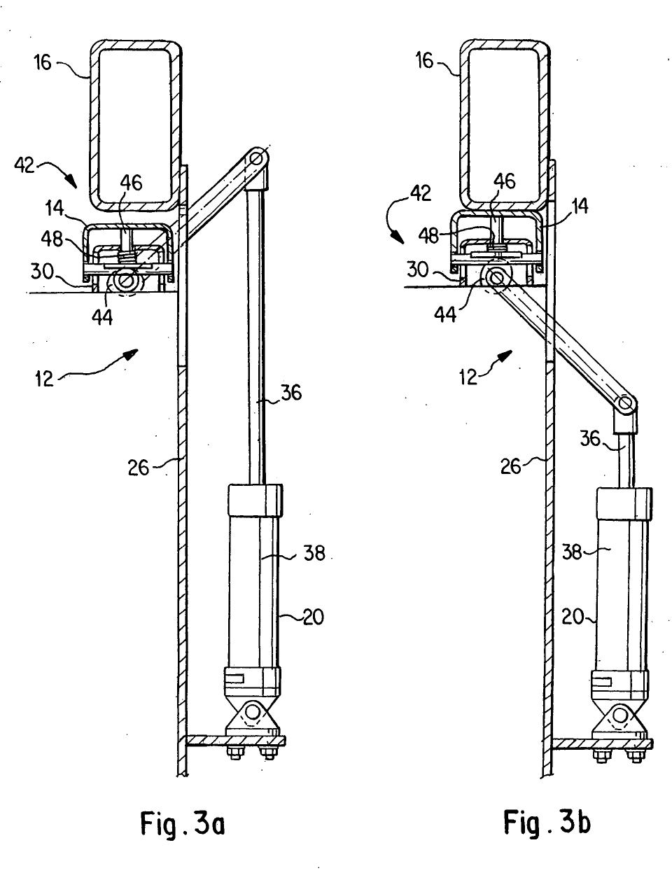

FIGS. 3a and 3b illustrate another preferred embodiment of the present invention. In this preferred embodiment, the side seal 42 of a pressure filter 12 includes first and second sealing members 14, 16, a cam 44, and an actuator 20.

The first and second sealing members 14, 16 of this preferred embodiment are substantially similar to those of the embodiment shown in FIGS. 2a and 2b. Therefore, the sealing members 14, 16 are not described in detail here.

The side seal 42 may also have a guide member 30 that is substantially similar to that of the embodiment shown in FIGS. 2a and 2b. Therefore, the guide member 30 also is not described in detail here.

The cam 44 preferably is pivotably or rotatably connected to the frame 26 of the pressure filter 12, although the pivotable arm can be pivotably or rotatably connected to any stationary object, including the guide member 30. The rotation of the cam 44 can move the first sealing member 14 towards the second sealing member 16 to engage the second sealing member 16, as shown in FIG. 3b. The cam 44 may directly engage the first sealing member 14, using the first sealing member 14 as a cam follower. Alternatively, as illustrated in FIGS. 3a and 3b, the cam 44 may directly engage a cam follower 46 that is connected to the first sealing member 14. The rotation of the cam 44 moves the cam follower 46 and thus indirectly the first sealing member 14.

A spring may be used to bias the first sealing member 14 towards the cam 44 and away from the second sealing member 16, if the first sealing member 14 is used as a cam follower. This ensures that the first sealing member 14 is in proper contact with the cam 44. On the other hand, if the cam follower 46 connected to the first sealing member 14 is used to engage the cam 44, as shown in FIGS. 3a and 3b, a spring 48 may be used to bias the cam follower 46 towards the cam 44 and away from the second sealing member 16. This ensures that the cam follower 46 is in proper contact with the cam 44.

The actuator 20 may also be substantially similar to that of the embodiment shown in FIGS. 2a and 2b. Therefore, the actuator 20 is not described in detail here.

In operation, from the position shown in FIG. 3a, compressed air is admitted to the piston rod side of the cylinder 38, pulling the piston 36 into the cylinder 38. This action causes the piston 36 to turn the cam 44 in the clock-wise direction. As a result, the cam 44 pushes the cam follower 46 (thus the first sealing member 14) towards the second sealing member 16 against the spring force until the sealing surfaces of the sealing members 14, 16 come into contact to form a seal, as shown in FIG. 3b. To disengage the sealing members 14, 16, the air in the cylinder is released, and the spring force pushes the cam follower 46 (thus the first sealing member 14) away from the second sealing member 16 to open up the gap between the sealing members 14, 16 and to pull the piston 36 out of the cylinder 38. Alternatively, a double acting piston/cylinder arrangement may be used as the actuator. The double acting piston/cylinder arrangement can be used to rotate the cam 44 in either direction to engage or disengage the sealing members 14, 16.

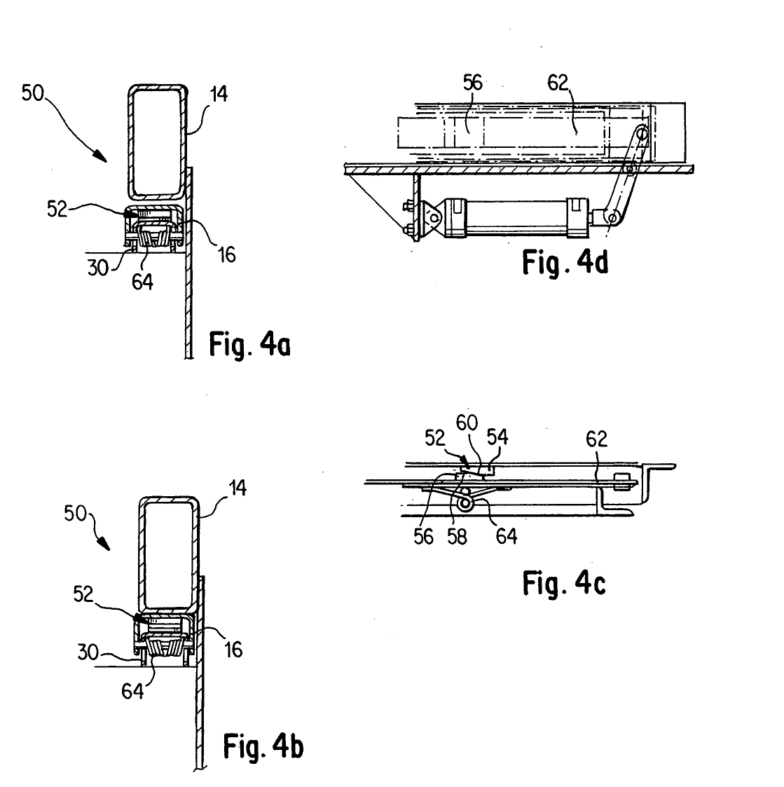

FIGS. 4a to 4d illustrate a further preferred embodiment of the present invention. In this preferred embodiment, the side seal 50 of a pressure filter 12 includes first and second sealing members 14, 16, a wedge mechanism 52, and an actuator 20.

The first and second sealing members 14, 16 of this preferred embodiment are substantially similar to those of the embodiment shown in FIGS. 2a and 2b. Therefore, the sealing members 14, 16 are not described in detail here.

The side seal 50 may also have a guide member 30 that is substantially similar to that of the embodiment shown in FIGS. 2a and 2b. Therefore, the guide member 30 also is not described in detail here.

The wedge mechanism 52 is used to move the first sealing member 14 towards or away from the second sealing member 16. As best shown in FIG. 4c, the wedge mechanism 52 may include first and second wedge members 54, 56. The first wedge member 54 preferably is attached to the first sealing member 14, and the second wedge member 56 can slide relative to the first wedge member 54 along, for example, a surface of the guide member 30. Each of the wedge members 54, 56 may have a wedge surface 58, 60, which can slide against each other. The slide of the wedge surfaces 58, 60 allows the wedge mechanism 52 to move the first sealing member 14 towards or away from the second sealing member 16. As shown in FIG. 4d, the second wedge member 56 is attached to a flat bar 62, which allows the second wedge member 56 to slide smoothly along a surface of the guide member 30.

A spring 64 may be used to bias the first sealing member 14 towards the wedge mechanism 52 and away from the second sealing member 16.

The actuator 20 also may be substantially similar to that of the embodiment shown in FIGS. 2a and 2b. Therefore, the actuator 20 is not described in detail here. The actuator 20 may be directly connected to the second wedge member 56 of the wedge mechanism 52, or it may be connected to the flat bar 62 to which the second wedge member 56 is attached. A pivotable bar 64 may also be used to connect the actuator 20 to the flat bar 62 or to the second wedge member 56. A double acting piston/cylinder arrangement may be used as the actuator. The double acting piston/cylinder arrangement can be used to move the second wedge member 56 in either direction to engage or disengage the sealing members 14, 16.

In operation, from the position shown in FIG. 4a, compressed air is admitted to the piston rod side of the cylinder 38, pulling the piston 36 into the cylinder 38. This action causes the piston 36 to move to the right. As a result, the wedge mechanism 52 pushes the first sealing member 14 towards the second sealing member 16 against the spring force until the sealing surfaces 22, 24 of the sealing members 14, 16 come into contact to form a seal, as shown in FIG. 4b. To disengage the sealing members 14, 16, the air in the cylinder is released, and the spring force pushes the first sealing member 14 away from the second sealing member 16 to open up the gap between the sealing members 14, 16 and to pull the piston 36 out of the cylinder 38.

As noted above in the Summary of the Invention, to the inventors' surprise and contrary to the common believes in the art, the side seals of the present invention, which use mechanical mechanisms 18, 44, 52, can function satisfactorily even though the mechanical mechanisms 18, 44, 52 do not applied a uniform pressure longitudinally along the sealing members. In fact, as shown in the drawings, the force applied by the mechanical mechanisms 18, 44, 52 is applied to only a single point on the first sealing member 14. This, however, did not prevent the mechanisms 18, 44, 52 from applying the side seal in a satisfactory manner.

1. A side seal of a pressure filter including a frame, the side seal comprising:
first and second sealing members, wherein the first sealing member is moveable relative to the second sealing member;
a pivotable arm that is pivotable relative to the frame, wherein the pivotable arm is engageable with the first sealing member, and wherein pivoting movement of the pivotable arm moves the fist sealing member to engage or disengage with the second sealing member; and
an actuator engageable with the pivotable arm, wherein the actuator is adapted to move pivotably the pivotable arm and in turn the first sealing member to engage or disengage with the second sealing member.

2. The side seal of claim 1, further comprising a spring that biases the first sealing member in a direction away from the second sealing member, wherein the actuator is adapted to move the first sealing member towards the second sealing member to engage with the second sealing member and wherein the spring is adapted to move the first sealing member away from the second sealing member to disengage with the second sealing member.

3. The side seal of claim 1, further comprising a spring that biases the first sealing member in a direction towards the second sealing member, wherein the actuator is adapted to move the first sealing member away the second sealing member to disengage with the second sealing member and wherein the spring is adapted to move the first sealing member towards the second sealing member to engage with the second sealing member.

4. The side seal of claim 1, further comprising a guide member fixed to the frame of the pressure filter, wherein the guide member guides the movement of the first sealing member towards or away from the second sealing member.

5. The side seal of claim 4, wherein the pivotable arm is pivotably connected to the guide member.

6. The side seal of claim 1, wherein the actuator includes a pneumatic actuator.

7. A side seal of a pressure filter including a frame, the side seal comprising:
first and second sealing members, wherein the first sealing member is moveable relative to the second sealing member;
a cam that is rotatable relative to the frame, wherein the rotation of the cam moves the fist sealing member to engage or disengage with the second sealing member; and
an actuator engageable with the cam, wherein the actuator is adapted to rotate the cam and in turn move the first sealing member to engage or disengage with the second sealing member.

8. The side seal of claim 7, further comprising a cam follower attached to the first sealing member, wherein the cam engages the cam follower to move the fist sealing member to engage or disengage with the second sealing member.

9. The side seal of claim 8, further comprising a spring that biases at least one of the cam follower and the first sealing member in a direction away from the second sealing member, wherein the actuator is adapted to rotate the cam to move the first sealing member towards the second sealing member to engage with the second sealing member and wherein the spring is adapted to move the first sealing member away from the second sealing member to disengage with the second sealing member.

10. The side seal of claim 8, further comprising a spring that biases at least one of the cam follower and the first sealing member in a direction towards the second sealing member, wherein the actuator is adapted to rotate the cam to move the first sealing member away the second sealing member to disengage with the second sealing member and wherein the spring is adapted to move the first sealing member towards the second sealing member to engage with the second sealing member.

11. The side seal of claim 7, further comprising a guide member fixed to the frame of the pressure filter, wherein the guide member guides the movement of the first sealing member towards or away from the second sealing member.

12. The side seal of claim 11, wherein the cam is pivotably connected to the guide member.

13. The side seal of claim 7, wherein the actuator includes a pneumatic actuator.

14. A side seal of a pressure filter including a frame, the side seal comprising:
first and second sealing members, wherein the first sealing member is moveable relative to the second sealing member;
a wedge mechanism including first and second wedge members, each wedge member having a wedge surface, the wedge surfaces of the wedge members being slidably engaged with each other, wherein the first wedge member is connected to the first sealing member; and
an actuator connected to the second wedge member of the wedge mechanism, wherein the actuator is adapted to move the second wedge member so that the wedge surface of the second wedge member slides relative to the wedge surface of the first wedge member to move the first sealing member to engage or disengage with the second sealing member.

15. The side seal of claim 14, further comprising a spring that biases the first sealing member in a direction away from the second sealing member, wherein the actuator is adapted to move the second wedge member so that the wedge surface of the second wedge member slides relative to the wedge surface of the first wedge member to move the first sealing member towards the second sealing member to engage with the second sealing member, and wherein the spring is adapted to move the first sealing member away from the second sealing member to disengage with the second sealing member.

16. The side seal of claim 14, further comprising a spring that biases the first sealing member in a direction away from the second sealing member, wherein the actuator is adapted to move the second wedge member so that the wedge surface of the second wedge member slides relative to the wedge surface of the first wedge member to move the first sealing member away from the second sealing member to disengage with the second sealing member, and wherein the spring is adapted to move the first sealing member towards the second sealing member to engage with the second sealing member.

17. The side seal of claim 14, further comprising a guide member fixed to the frame of the pressure filter, wherein the guide member guides the movement of the first sealing member towards or away from the second sealing member.

18. The side seal of claim 14, further comprising a pivotable arm, wherein the actuator is connected to the second wedge member of the wedge mechanism via the pivotable arm.

19. The side seal of claim 18, further comprising a flat bar connected to the second wedge member, wherein the actuator is connected to the second wedge member via the flat bar and moves the flat bar using the pivotable arm.

20. The side seal of claim 14, wherein the actuator includes a pneumatic actuator.
